(19) United States
(12) Patent Application Publication
(10) Pub. No.: US 2006/0257531 A1
(43) Pub. Date: Nov. 16, 2006

(54) Fruit bar and method of making a fruit bar

(76) Inventors: Guoshen Yang, Battle Creek, MI (US); Gary Charles Garfield, Battle Creek, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/434,948

(22) Filed: May 16, 2006

Related U.S. Application Data
(60) Provisional application No. 60/681,403, filed on May 16, 2005.

(51) Int. Cl. A23B 7/16

(52) U.S. Cl. 426/102

(57) ABSTRACT

The invention provides a fruit bar and a method for making a fruit bar. The fruit bar includes primary fruit pieces having a taste and a texture. The texture of the primary fruit pieces is defined at least in part by a hardness and a chewiness and a roughness. The fruit bar also includes secondary fruit pieces combined with the primary fruit pieces. The secondary fruit pieces are of different fruit than the primary fruit pieces. The secondary fruit pieces have a taste and a texture defined at least in part by a hardness and a chewiness and a roughness. In the fruit bar, the taste and the roughness of the first and secondary fruit pieces are different from one another to provide a varied taste and mouthfeel to the consumer. The chewiness and the hardness of the first and secondary fruit pieces are substantially the same to provide a substantial uniformity of bite and chew to the consumer.

### CROSS-REFERENCE TO RELATED APPLICATIONS

This application claims the benefit of U.S. Provisional Patent Application Ser. No. 60/681,403 for a FRUIT BAR AND METHOD FOR MAKING A FRUIT BARS, filed on May 16, 2005, which is hereby incorporated by reference in its entirety.

### BACKGROUND OF THE INVENTION

1. Field of the Invention

The subject invention relates to fruit bars and methods of making fruit bars. More specifically, the subject invention relates to fruit bars having discrete fruit pieces that retain a distinct structure in the final fruit bar.

2. Description of Related Prior Art

Fruit can be processed to form gelled fruit pieces, fruit leathers, and fillings for snack bars. The fruit can be pureed, mashed, or pulverized. In raw form, each kind of fruit has a different taste and different properties in terms of texture or mouthfeel. In forming gel pieces, fruit leathers, and fillings, the texture of fruit changes.

### SUMMARY OF THE INVENTION

The invention provides a fruit bar and a method for making a fruit bar. The fruit bar includes primary fruit pieces having a taste and a texture. The texture of the primary fruit pieces is defined at least in part by a hardness and a chewiness and a roughness. The fruit bar also includes secondary fruit pieces combined with the primary fruit pieces. The secondary fruit pieces are of different fruit than the primary fruit pieces. The secondary fruit pieces have a taste and a texture defined at least in part by a hardness and a chewiness and a roughness. In the fruit bar, the taste and the roughness of the first and secondary fruit pieces are different from one another to provide a varied taste and mouthfeel to the consumer. The chewiness and the hardness of the first and secondary fruit pieces are substantially the same to provide a substantial uniformity of bite and chew to the consumer.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of a first embodiment of the invention;

FIG. 2 is a top view of two examples of the first embodiment of the invention;

FIG. 3 is a simplified flow diagram of a process for making a fruit bar according to an exemplary embodiment of the invention;

FIG. 4 is a perspective view of the two examples shown in FIG. 2; and

FIG. 5 is a bottom view of the two examples shown in FIGS. 2 and 4.

### DETAILED DESCRIPTION OF THE PREFERRED EMBODIMENT

The invention provides a fruit bar and a method of making the fruit bar. The exemplary fruit bar set forth below has a diverse agglomerated appearance and includes a sweetening composition, edible oil, fruit flavoring, coloring, and discrete fruit pieces. The discrete fruit pieces are present on a solid weight basis in an amount of at least 60 parts by weight based on the total weight of the fruit bar and create the diverse agglomerated appearance in the final fruit bar.

An exemplary method of making the fruit bar is also set forth below and includes first preparing a sweetening composition. The sweetening composition is heated to a temperature of at least 160° F. At least one semi-dried primary fruit is mixed into the sweetening composition. The composition with the semi-dried primary fruit is heated to a temperature of at least 160° F. for a first period of time. Secondary fruits are then mixed into the composition after the first period of time. The composition including the primary fruit and the secondary fruit is then formed into fruit bars.

By mixing the semi-dried primary fruit pieces into the sweetening composition and heating the composition for the first period of time prior to adding the secondary fruits, the primary fruit is subjected to additional cooking time, which allows the sweetening composition to infuse into the semi-dried primary fruit and softens the hardness and reduces chewiness of the primary fruit to a hardness and chewiness similar to the secondary fruits. However, each of the primary and secondary fruits retains its own taste and roughness. As a result, the fruit pieces in the fruit bar all have similar textural qualities resulting in a uniform bite and chew. On the other hand, the process allows the primary and secondary fruits to retain distinct attributes resulting in a varied taste and mouthfeel experience. The semi-dried primary fruit is sufficiently cooked without destroying the integrity of the secondary fruits to maintain the diverse agglomerated appearance, taste and mouthfeel in the final fruit bar.

The texture of a food product can be quantified by several techniques, such as those based on rheological principles that can be measured by instruments as well as by psychophysical methods. The Texture Profile Analysis (TPA) developed by A. S. Szczesniak is one example. In the Szczesniak model, the textural characteristics of food are defined in view of mechanical, geometrical, and other properties. The mechanical properties include hardness, cohesiveness, viscosity, elasticity, adhesiveness, brittleness or fracturability, chewiness, gumminess, and resilience. The geometrical properties include the size and shape of particles and the shape and orientation of the particles. The other properties include moisture content, oiliness and greasiness. Equipment to measure characteristics relating to food texture can be acquired from Texture Technologies of 18 Fairview Road, Scarsdale, N.Y. 10583.

Hardness can be determined by placing a sample of the food product between molar teeth and biting down evenly, evaluating the force required to compress the food. Hardness can also be defined by the force required to deform the food product a particular amount. For example, the hardness value can be the peak force of the first compression of the product. The hardness need not occur at the point of deepest compression, although it typically does for most products.

Chewiness can be determined by placing a sample of the food product in the mouth, masticating at one chew per second at a force equal to that required to penetrate a gum drop in 0.5 seconds, and evaluating the number of chews required to reduce the sample to a state ready for swallowing. Chewiness relates to the number of chews at 1 chew/sec needed to masticate the sample to a consistency suitable for swallowing. Chewiness only applies for solid products and is related to Gumminess and Springiness. Chewiness can be considered mutually exclusive with respect to Gumminess if a product will not be considered both a solid and a semi-solid at the same time.

Other characteristics of food texture have also been identified. Roughness relates to the degree of abrasiveness of the food product's surface as perceived by the tongue. The Uniformity of Chew relates to the degree to which the chewing characteristics of the product are even throughout mastication. The Uniformity of Bite relates to the evenness or consistency of the force required to bite through the product.

Referring to the Figures, wherein like numerals indicate like or corresponding parts throughout the several views, a fruit bar 10 is shown in FIG. 1. The fruit bar 10 has discrete fruit pieces to enhance the appearance of wholesomeness, which appeals to consumers, especially those who aspire to health-conscious diets.

Preferably, the discrete fruit pieces are in diced, chunked, or whole form prior to processing so that the fruit pieces may remain in discrete form in the final fruit bar 10. Preferably, the discrete fruit pieces are selected from the group of, but not limited to, strawberry, apple, cranberry, pineapple, peach, blueberry, cherry, peach, pear, apricot, and combinations thereof. Most preferably, the discrete fruit pieces include a mixture of diced apples and cranberries.

The fruits added to the bar 10 can be characterized as either primary fruits 12 or secondary fruits 13 depending upon the point at which point they are added during cooking step of the process for making the fruit bar 10. The primary fruit 12 provides structure and integrity to the final fruit bar 10. In the exemplary embodiment of the invention, the primary fruit 12 is selected from the group of semi-dried apple, semi-dried peach, semi-dried apricot, semi-dried pear, and combinations thereof. Examples of semi-dried apples that are suitable for the subject invention are made from Fuji apples, Golden Delicious apples, Granny Smith apples, and combinations thereof, which are commercially available from Treetop, Inc. Other specific examples of semi-dried primary fruits that are suitable for the subject invention include semi-dried peach, apricot, and pear pieces. Preferably, the semi-dried primary fruit 12 has a moisture content of from 8-22 parts by weight, more preferably about 12 to 15 parts by weight, based on the total weight of the semi-dried primary fruit 12. The semi-dried primary fruit 12 having the preferred moisture content provides processing advantages over fruit that has higher moisture content. For example, the semi-dried primary fruit 12 having the preferred moisture content is more likely to retain its structure and integrity after processing.

The semi-dried primary fruit 12 is present in the fruit bar 10 in an amount of from 30 to 60 parts by weight based on the total weight of the fruit bar 10. More preferably, the semi-dried primary fruit 12 is present in an amount of from 38 to 48 parts by weight, based on the total weight of the fruit bar 10. On a dry weight basis, given the above-mentioned range of moisture content, the semi-dried primary fruit 12 is most preferably present in an amount of from 32 to 40 parts by weight based on the total weight of the fruit bar 10.

Preferably a secondary fruit 13 is interspersed with the semi-dried primary fruit 12 in the fruit bar 10 to add variety to the appearance and to the taste of the fruit bar 10. The secondary fruits 13 can be selected from the group of cranberries, blueberries, pineapples, strawberries, cherries, soft peaches, soft pears, soft apples, raisins, black currants, and combinations thereof. Specific examples of secondary fruits 13 that are suitable for the subject invention include peaches and pineapples commercially available from Mariani Packing Company and diced cranberry commercially available from Ocean Spray, Inc. Preferably, the secondary fruits 13 are also semi-dried and have a moisture content of from 10 to 28 parts by weight, more preferably about 14 to 18 parts by weight, based on the total weight of the secondary fruits 13. The secondary fruits can also be the pieces of fruits mentioned above that have been sugar infused.

The secondary fruits 13 are present in an amount of up to 30 parts by weight based on the total weight of the fruit bar 10. In a more preferred embodiment, the secondary fruits 13 are present in an amount of from 15 to 30 parts by weight, most preferably about 20 parts by weight, based on the total weight of the fruit bar 10. Thus, on a dry weight basis, the secondary fruits 13 are preferably present in an amount of from 17 to 25 parts by weight based on the total weight of the fruit bar 10.

Fruit juices, fruit juice concentrates, fruit purees and fruit puree concentrates, may also be included in the fruit bar 10 for improving the taste and mouthfeel of the fruit bar 10. For example, the fruit bar 10 preferably includes strawberry puree and/or juice concentrate. A specific example of a fruit puree concentrate that is suitable for the subject invention is strawberry puree commercially available from Sabroso, Inc. Other examples of fruit juices, fruit juice concentrates, fruit puree and purees concentrates that may be suitable for the subject invention include, but are not limited, to cranberry juice concentrate having from 20 to 75 Brix, apple juice concentrate having from 30 to 75 Brix, strawberry puree concentrate having from 14 to 50 Brix, and peach puree concentrate having from 20 to 50 Brix.

When used, the fruit juices, fruit juice concentrates, and purees are present in an amount of up to 10 parts by weight based on the total weight of the fruit bar 10. More preferably, the fruit juices, fruit juice concentrates, and purees are present in an amount of from 2 to 8, most preferably about 5 parts by weight, based on the total weight of the fruit bar 10. Preferably, the fruit purees have a Brix of from 14 to 50 Brix and the fruit juice concentrate has a Brix of from 20 to 75. The juice or puree concentrate can be added into the sweetening composition, such as the sweetening composition described below. Fruit paste with 50-75 Brix may also be added instead or in combination of fruit juice or fruit puree.

Preferably, a total amount of the primary fruit 12, secondary fruit 13, fruit juice, fruit juice concentrate, puree, puree concentrate is present on a solid weight basis in an amount of at least 50 parts by weight based on the total weight of solids in the fruit bar 10 for creating the diverse agglomerated appearance in the fruit bar 10. As a result, the fruit bar 10 appears to comprise all fruit, with moisture in the fruit and other components forming the balance of the fruit bar 10.

In addition to the discrete fruit pieces 12, 13, fruit juice concentrate, and purees, the fruit bar 10 includes a sweetening composition. The sweetening composition is included to further improve the taste of the fruit bar 10, in conjunction with the fruits set forth above, and also acts as a filler. Preferably, the sweetener is selected from the group of, but is not limited to, dextrose, fructose, sucrose, corn syrup, non-carbohydrate sweeteners, and combinations thereof. In a most preferred embodiment, the sweetener includes a combination of 42 D.E. (dextrose equivalent) corn syrup, sucrose, and dextrose.

Preferably, the sweetener is present in an amount of from 10 to 30 parts by weight based on the total weight of the fruit bar 10. In a more preferred embodiment, the sweetener is present in an amount of from 15 to 25 parts by weight, most preferably about 20 parts by weight, based on the total weight of the fruit bar 10 to provide the desired sweetness to the fruit bar 10.

Preferably, edible oil, fruit flavoring, and, optionally, natural or artificial coloring are also included in the fruit bar 10 in small amounts. The edible oil is included to enhance flavor characteristics and to control the stickiness of the fruit bar 10. In a preferred embodiment, the edible oil is a high stability vegetable oil, such as high oleic sunflower oil or high oleic canola oil. However, shortenings such as partially hydrogenated soybean and cotton seed oils are also suitable. Preferably, the edible oil is present in an amount of from 1 to 3 parts by weight, more preferably from 2 to 3 parts by weight, most preferably about 2.5 parts by weight, based on the total weight of the fruit bar 10. An example of edible oil suitable for the subject invention is high oleic sunflower oil.

The fruit flavoring is included to further improve the taste of the fruit bar 10 and is preferably selected from the group of red fruit flavor, strawberry flavor, mixed berry flavor, peach flavor, mango flavor, tropical flavor, and combinations thereof. In a most preferred embodiment, the fruit flavoring is a combination of red fruit flavor and strawberry flavor. Preferably, the fruit flavor is present in an amount of from 0.01 to 1 part by weight, more preferably from 0.1 to 0.5 parts by weight, most preferably about 0.2 parts by weight, based on the total weight of the fruit bar 10. A specific example of a fruit flavoring that is suitable for the subject invention is red fruit flavoring commercially available from Firmenich, Inc.

Referring to Table 1, the preferred ranges for the components of the fruit bar 10 are set forth, wherein fruit solids indicate the total fruit mass without moisture, and all values are in parts by weight based on the total weight of the fruit bar 10.

TABLE 1

| | Preferred |
|---|---|
| Component | Range |
| Total Amount of Fruit Solids | ≧50 |
| Total Amount of Sweeteners | 10-30 |
| Edible Oil (Toffita) | 2-3 |
| Total Amount of Fruit Flavoring | 0.1-0.5 |

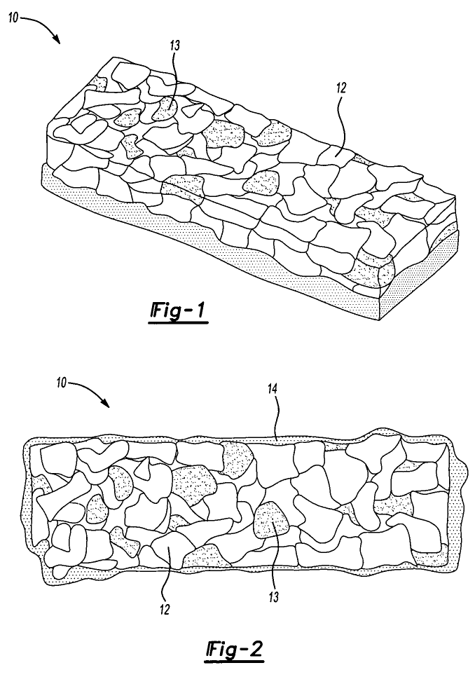

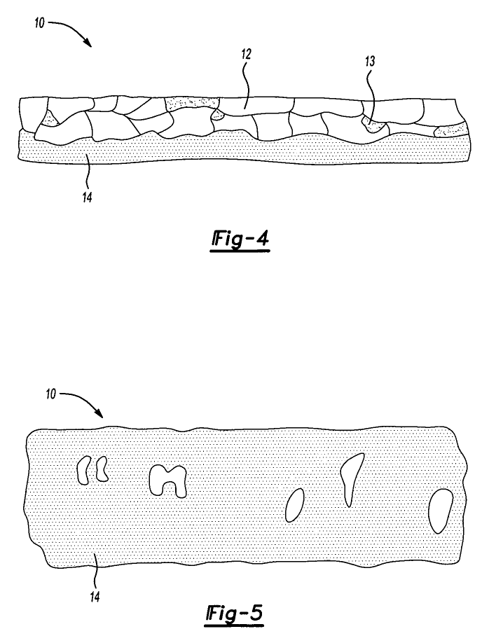

As best shown in FIGS. 2, 4 and 5, a coating 14 may be applied to the fruit bar 10. Preferably, the coating 14 comprises at least one of chocolate and yogurt; however, any other common compound coating is suitable. Furthermore, additional food pieces (not shown) may be embedded in the coating 14. The coating 14 may partially or completely enrobe the final fruit bar 10. The coating 14 may also be a compound coating as is known in the art. When the coating 14 is present, the fruit bar 10 preferably comprises the coating 14 in an amount of less than or equal to 30 parts by weight based on the total weight of the fruit bar 10.

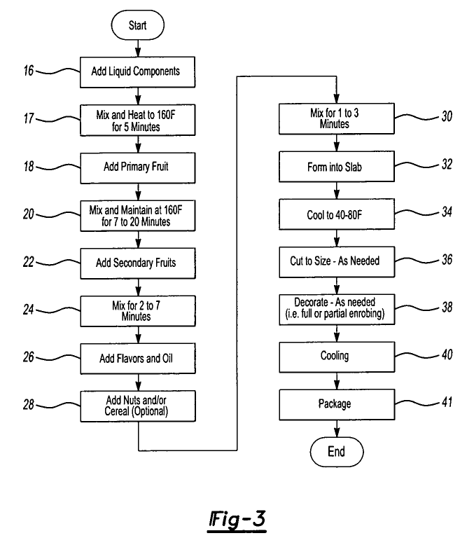

A flow chart illustrating an exemplary method of making the fruit bar 10 is shown in FIG. 3. The method of making the fruit bar 10 includes the step 16 of combining the liquid components to prepare the sweetening composition. The sweetening composition is prepared by adding the liquid components, such as sweetener, water, fruit juice concentrates, and purees, and about half of the fruit flavoring. The liquid components are combined in a into a steam-jacketed cooking vessel. The liquid components are gently mixed by, for example, scraped surface agitation. Continuous mix preparation can be alternatively used to combine and mix the liquid components. As set forth above, the sweetening composition can be 20%-30% of the total weight of the fruit bar 10. The sweetening composition is heated to a temperature of about 160° F. and mixed for a period of about 5 minutes at step 17.

At step 18, the primary fruit 12 is added to the sweetening composition. The semi-dried primary fruit 12 is added at this point to allow for additional cooking time of the primary fruit 12, as compared to the secondary fruits 13, which enables the sweetening composition to infuse into the semi-dried primary fruit 12 pieces to improve the taste and texture of the semi-dried primary fruit 12 and to soften the texture and firmness of the semi-dried primary fruit 12 to a texture similar to the secondary fruits 13. Furthermore, the semi-dried primary fruit 12 is more resilient than the secondary fruits 13. As a result, the semi-dried primary fruit 12 is sufficiently cooked without destroying the integrity of the secondary fruits 13 to maintain the diverse agglomerated appearance in the fruit bar 10. As set forth above, the semi-dried fruit 12 can be 40%-50% of the total weight of the fruit bar 10. After the semi-dried primary fruit 12 is added, the composition is maintained at the temperature of at least 160° F. and mixed for a period of from 7 to 20 minutes in step 20.

The secondary fruits 13 are then added to the composition at step 22. As set forth above, the secondary fruits 13 can be 20%-30% of the total weight of the fruit bar 10. The composition including the secondary fruits 13, in addition to the primary fruit 12, is mixed for a period of from 2 to 7 minutes at step 24.

The rest of the fruit flavoring and edible oil are then added to the composition at step 26. Nuts and cereal may be contemporaneously added to the composition with the flavors and oil at step 28 if desired. The composition is then mixed for a period of from 1 to 3 minutes at step 30. If the fruit bar 10 contains oil, the oil can be added at this last stage of cooking.

The mixture is then formed into the fruit bars 10. More specifically, the mixture is sent to a hopper and fed between a pair of rollers. The rollers flatten the mixture into a slab at step 32. The slab is cooled to a temperature of from 40 to 80° F. at step 34. After cooling the slab, the slab is slit by knives into multiple fruit bars 10 at step 36. The final fruit bars 10 have a moisture content of from 12 to 17% and a water activity of from 0.45 to 0.7. The fruit bars 10 may then be decorated by being coated or enrobed, either fully or partially, with chocolate, yogurt, or known compound coatings at step 38 if desired. The fruit bars 10 are further cooled and packaged at steps 40 and 41.

### EXAMPLES

Examples of fruit bars 10 of the subject invention were made according to the method set forth above. Table 2 sets forth the specific components and amounts of the components used to make the fruit bars 10, with all values based on the total weight of the respective fruit bars 10.

TABLE 2

| | EXAMPLE 1 | | EXAMPLE 2 | |
|---|---|---|---|---|
| | Amount, w/ | Amount, | Amount, w/ | Amount, |
| Component | Moisture | Dry Basis | Moisture | Dry Basis |
| Primary Fruit | 44.00 | 37.84 | 38.25 | 32.90 |
| Puree A | 5.00 | 1.40 | 0 | 0 |
| Secondary Fruit A | 20.81 | 17.69 | 0 | 0 |
| Secondary Fruit B | 0 | 0 | 14.30 | 12.87 |
| Secondary Fruit C | 0 | 0 | 13.78 | 11.58 |
| Total Amount of | 69.81 | 56.93 | 66.33 | 57.35 |
| Fruit | | | | |
| Sweetener A | 10.85 | 7.82 | 10.95 | 8.98 |
| Sweetener B | 5.00 | 5.00 | 5.00 | 5.00 |
| Sweetener C | 5.00 | 5.00 | 5.00 | 5.00 |
| Total Amount of | 20.85 | 17.82 | 20.95 | 18.98 |
| Sweeteners | | | | |
| Fruit Flavor A | 0.10 | 0.05 | 0 | 0 |
| Fruit Flavor B | 0.10 | 0.05 | 0 | 0 |
| Fruit Flavor C | 0 | 0 | 0.22 | 0.20 |
| Other | | | | |
| Components | | | | |
| Water | 6.44 | 0 | 10 | 0 |
| Fat A | 2.70 | 2.69 | 2.50 | 2.49 |
| Total | 100.00 | 77.54 | 100.00 | 79.02 |

Wherein:

Primary Fruit is semi-dried Fuji apple having 14 parts by weight of moisture, based on the total weight of the apple, commercially available from Treetop, Inc.

Puree A is strawberry puree having 72 parts by weight of moisture, based on the total weight of the puree, commercially available from Ocean Spray Cranberries, Inc.

Secondary Fruit A is semi-dried cranberry dice having 15 parts by weight of moisture, based on the total weight of the cranberry, commercially available from Ocean Spray Cranberries, Inc.

Secondary Fruit B is pineapple having 10 parts by weight of moisture, based on the total weight of the pineapple, commercially available from Mariani.

Secondary Fruit C is diced peach having 16 parts by weight of moisture, based on the total weight of the diced peach, commercially available from Mariani.

Sweetener A is 42 D.E. glucose syrup having 28 parts by weight of moisture, based on the total weight of the glucose syrup.

Sweetener B is sucrose.

Sweetener C is dextrose.

Fruit Flavor A is red fruit flavor commercially available from Firmenich.

Fruit Flavor B is strawberry flavor commercially available from Firmenich.

Fruit Flavor C is tropical flavor.

Fat A is high oleic sunflower oil.

The invention has been described in an illustrative manner, and it is to be understood that the terminology which has been used is intended to be in the nature of words of description rather than of limitation. Obviously, many modifications and variations of the present invention are possible in light of the above teachings, and the invention may be practiced otherwise than as specifically described.

What is claimed is:

1. A fruit bar comprising:
primary fruit pieces having a taste and a texture defined at least in part by a hardness and a chewiness and a roughness; and
secondary fruit pieces combined with said primary fruit pieces wherein said secondary fruit pieces are of different fruit than said primary fruit pieces and have a taste and a texture defined at least in part by a hardness and a chewiness and a roughness wherein said taste and said roughness of said first and secondary fruit pieces are different from one another and wherein said chewiness and said hardness of said first and secondary fruit pieces are substantially the same.

2. The fruit bar of claim 1 wherein said secondary fruit pieces are further defined as adhered directly to said primary fruit pieces with a sweetening composition.

3. The fruit bar of claim 1 wherein said primary fruit pieces and said secondary fruit pieces are differently sized from one another.

4. The fruit bar of claim 1 wherein said primary fruit pieces and said secondary fruit pieces are differently shaped from one another.

5. The fruit bar of claim 1 wherein said primary fruit pieces and said secondary fruit pieces have different moisture contents.

6. The fruit bar of claim 5 wherein said primary fruit pieces have a moisture content of between 8-22 parts by weight and said secondary fruit pieces have a moisture content of between 10-28 parts by weight.

7. The fruit bar of claim 1 wherein said first and secondary fruit pieces are at least 60% of a total weight of the fruit bar.

8. The fruit bar of claim 7 wherein said first and secondary fruit pieces are 80% of the total weight of the fruit bar.

9. The fruit bar of claim 1 wherein said primary fruit pieces are between 40%-50% of a total weight of the fruit bar and said secondary fruit pieces are between 20%-30% of the total weight of the fruit bar.

10. A method of making a fruit bar comprising the steps of:
providing primary fruit pieces having a taste and a texture defined at least in part by a hardness and a chewiness and a roughness; and
combining the primary fruit pieces with secondary fruit pieces of different fruit than said primary fruit pieces and having a taste and a texture defined at least in part by a hardness and a chewiness and a roughness wherein said taste and said roughness of said first and secondary fruit pieces are different from one another and wherein said chewiness and said hardness of said first and secondary fruit pieces are substantially the same.

11. The method of claim 10 further comprising the steps of:
reducing the hardness and chewiness of the primary fruit pieces by cooking for a first period of time in a sweetening composition;
adding the secondary fruit pieces to the primary fruit pieces in the sweetening composition after the first period of time;
cooking the primary and secondary fruit pieces together in the sweetening composition for a second period of time; and
maintaining an integrity of the secondary fruit pieces during the second period of time.

12. The method of claim 11 wherein said reducing step is further defined as:
reducing the hardness and chewiness of the primary fruit pieces by cooking at 160° F. for a first period of time lasting 7 to 20 minutes in a sweetening composition

13. The method of claim 12 wherein said cooking step is further defined as:
cooking the primary and secondary fruit pieces together at 160° F. in the sweetening composition for a second period of time lasting 2 to 7 minutes.

14. The method of claim 10 wherein said providing step includes the step of:
selecting semi-dried fruit for the primary fruit pieces to enhance a structural integrity of the fruit bar.

15. The method of claim 10 including the step of:
selecting primary and secondary fruit pieces having different moisture contents.

16. The method of claim 10 including the step of:
adding one of fruit juices, fruit juice concentrates, and puree to the combined primary and secondary fruit pieces up to 10 parts by weight of the fruit bar.

17. The method of claim 10 including the step of:
adding sweetener to the combined primary and secondary fruit pieces in an amount of from 10 to 30 parts by weight of the fruit bar.

18. The method of claim 10 including the step of:
adding one of nuts and cereal to the combined primary and secondary fruit pieces.

19. The method of claim 10 including the step of:
at least partially enrobing the combined primary and secondary fruit pieces with one of chocolate and yogurt.
